(19) United States
(12) Patent Application Publication
(10) Pub. No.: US 2026/0169975 A1
(43) Pub. Date: Jun. 18, 2026

(54) SHEET DATA PROCESSING METHOD, COMPUTER DEVICE AND STORAGE MEDIUM

(71) Applicant: Beijing Zitiao Network Technology Co, Ltd., Beijing (CN)

(72) Inventors: Mingtao LUO, Beijing (CN); Zhanhong LUO, Beijing (CN)

(21) Appl. No.: 19/415,699

(22) Filed: Dec. 10, 2025

(30) Foreign Application Priority Data
Dec. 12, 2024 (CN) 202411835211.7

(51) Int. Cl. G06F 16/23; G06F 16/26

(52) U.S. Cl. CPC G06F 16/2358; G06F 16/26

(57) ABSTRACT

The present disclosure provides a sheet data processing method, a computer device, and a storage medium. The method includes: obtaining input data in a sheet, and determining at least one calculation formula affected by the input data; determining basic data corresponding to the calculation formula according to a node backend service, and writing the input data and the basic data into a calculation engine; determining a data list affected by the calculation formula by using the node backend service, and passing the calculation formula to the calculation engine to calculate the data list, to generate a calculation result; determining, according to the calculation result, a data item in the data list that changes after the calculation, and performing data updating on the data item; and displaying an updated data list in the sheet.

### CROSS-REFERENCE TO RELATED APPLICATION

This application claims the priority to and benefits of the Chinese Patent Application, No. 202411835211.7, which was filed on Dec. 12, 2024. The aforementioned patent application is hereby incorporated by reference in its entirety.

### TECHNICAL FIELD

The present disclosure relates to the field of computer technologies, and in particular, to a sheet data processing method, a computer device, and a storage medium.

### BACKGROUND

In the current service field, after one piece of data is obtained in a sheet, some data that already exist currently need to be updated. For example, when new turnover is entered, daily turnover, monthly turnover, a profit margin, and the like are affected, and data updating needs to be performed. The affected data is generally calculated by using a corresponding formula.

In some scenarios, as the number of formulas involved in calculation increases, the complexity of the formulas increases, and the like, problems such as a long calculation time and high memory usage gradually become prominent, and the overall reaction efficiency, the calculation cost, and the like are affected, seriously affecting the user experience.

### SUMMARY

In view of this, the present disclosure provides a sheet data processing method and apparatus, a computer device, and a storage medium to solve or partially solve the above problems.

Based on the above objective, the present disclosure provides a sheet data processing method, comprising:
obtaining input data in a sheet, and determining at least one calculation formula affected by the input data;
determining basic data corresponding to the calculation formula according to a node backend service, and writing the input data and the basic data into a calculation engine;
determining a data list affected by the calculation formula by using the node backend service, and passing the calculation formula to the calculation engine to calculate the data list, to generate a calculation result;
determining, according to the calculation result, a data item in the data list that changes after the calculation, and performing data updating on the data item; and
displaying an updated data list in the sheet.

The present disclosure provides a sheet data processing apparatus, comprising:
a first module configured to obtain input data in a sheet, and determine at least one calculation formula affected by the input data;
a second module configured to determine basic data corresponding to the calculation formula according to a node backend service, and write the input data and the basic data into a calculation engine;
a third module configured to determine a data list affected by the calculation formula by using the node backend service, and pass the calculation formula to the calculation engine to calculate the data list, to generate a calculation result;
a fourth module configured to determine, according to the calculation result, a data item in the data list that changes after the calculation, and perform data updating on the data item; and
a fifth module configured to display an updated data list in the sheet.

The present disclosure provides a computer device, comprising at least a memory, at least a processor, and a computer program stored in the memory and executable by the processor, where the processor, when executing the program, implements the method according to the first aspect.

The present disclosure provides a non-transitory computer-readable storage medium for storing computer instructions thereon, wherein the computer instructions, when executed by at least a computer, cause the computer to perform the method according to the first aspect.

### BRIEF DESCRIPTION OF DRAWINGS

To describe the technical solutions in the embodiments of the present disclosure or in the related art more clearly, the following briefly introduces the drawings required for describing the embodiments or the related art. Apparently, the drawings in the following description show merely some embodiments of the present disclosure, and a person of ordinary skill in the art may still derive other drawings from these drawings without creative efforts.

FIG. 1 is a schematic diagram of an exemplary system 100 according to an embodiment of the present disclosure.

FIG. 2 is a schematic flowchart of an exemplary method 200 according to an embodiment of the present disclosure.

FIG. 3 is a schematic diagram of an exemplary apparatus 300 according to an embodiment of the present disclosure.

FIG. 4 is a schematic diagram of an exemplary computer device 400 according to an embodiment of the present disclosure.

### DETAILED DESCRIPTION

To make the objectives, technical solutions, and advantages of this specification clearer, this specification is further described in detail below with reference to specific embodiments and the drawings.

It should be noted that unless otherwise defined, the technical or scientific terms used in the embodiments of the present disclosure shall have general meanings as understood by those of ordinary skill in the art to which the present disclosure pertains. “first”, “second”, and like words used in examples of the present disclosure do not represent any order, quantity, or importance, but are merely used to distinguish between different components. “comprise” or “include” or like words mean that an element or item preceding the term encompasses an element or item or its equivalent listed after the term, without excluding other elements or items. “connect” or “connected” or like words are not limited to a physical or mechanical connection, but may comprise an electrical connection, whether direct or indirect. “up”, “down”, “left”, “right”, and the like are merely used to represent a relative positional relationship, and when an absolute position of the described object changes, the relative positional relationship may also change accordingly.

It may be understood that before the technical solutions disclosed in the embodiments of the present disclosure are used, the user shall be informed of the type, range of use, use scenarios, etc., of personal information involved in the present disclosure and the authorization of the user shall be obtained in an appropriate manner in accordance with relevant laws and regulations.

For example, in response to receiving an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also comprise a selection control for the user to select whether to “agree” or “disagree” to provide the personal information to the electronic device.

It may be understood that the above process of notifying and obtaining user authorization is merely illustrative and does not constitute a limitation on the implementations of the present disclosure, and other manners that satisfy the relevant laws and regulations may also be applied in the implementations of the present disclosure.

It may be understood that the data involved in the technical solutions (comprising, but not limited to, the data itself, acquisition or use of the data) shall comply with requirements of corresponding laws, regulations, and related provisions.

To make the objectives, technical solutions, and advantages of this specification clearer, this specification is further described in detail below with reference to specific embodiments and the drawings.

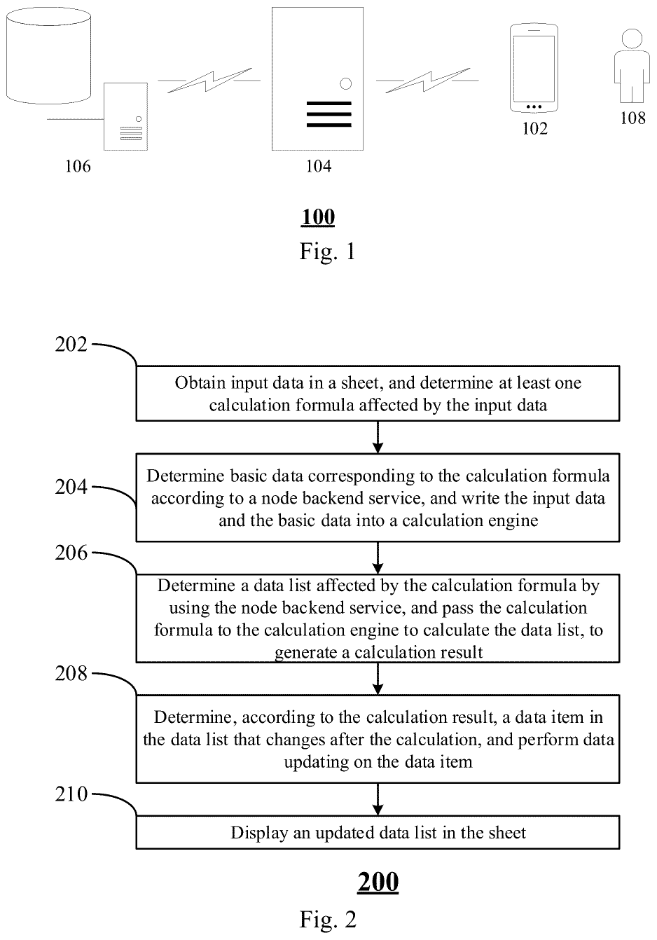

FIG. 1 is a schematic diagram of an exemplary system 100 according to an embodiment of the present disclosure. The system 100 may be a system for implementing corresponding sheet data processing.

As shown in FIG. 1, taking an object display method performed jointly by a terminal device and a server as an example, the system 100 may comprise a terminal device 102, a server 104, and a database server 106. The terminal device 102 and the server 104 are connected to each other through a network, for example, through a wired or wireless network. Optionally, an apparatus for implementing sheet data processing may be integrated in the terminal device 102. The database server 106 and the server 104 are connected to each other through a network, for example, through a wired or wireless network. The database server 106 may store various data related to the execution of the data processing method, such as a calculation formula, corresponding basic data, and a data list.

Various applications (Application, APP) may be installed on the terminal device 102, such as an image processing application, a video conference application, a life service application, a reading application, a video application, a social application, a payment application, a web browser, and an instant messaging tool. These applications may all be used for inputting input data or displaying a data list (before or after updating). As an optional example, the application (APP) installed on the terminal device 102 may be downloaded from the server 104 and installed.

The terminal device 102 here may be hardware or software. When the terminal device 102 is hardware, it may be various electronic devices having a display screen, comprising but not limited to a smartphone, a tablet computer, an e-book reader, an MP3 player, a laptop portable computer (Laptop), a desktop computer (PC), etc. When the terminal device 102 is software, it may be installed in the electronic devices listed above. It may be implemented as a plurality of pieces of software or software modules (for example, for providing distributed services), or may be implemented as a single piece of software or a single software module. This is not specifically limited herein.

The server 104 may be a server that provides various services. For example, it is a back-end server that provides support for various applications displayed on the terminal device 102. The database server 106 may also be a database server that provides various services. It may be understood that when the server 104 may implement the related functions of the database server 106, the database server 106 may be omitted from the system 100.

The server 104 and the database server 106 here may also be hardware or software. When they are hardware, they may be implemented as a distributed server cluster composed of a plurality of servers, or as a single server. When they are software, they may be implemented as a plurality of pieces of software or software modules (for example, for providing distributed services), or may be implemented as a single piece of software or a single software module. This is not specifically limited herein.

It should be noted that the sheet data processing method provided in the embodiments of the present disclosure may be performed by the system 100. Specifically, it may be performed through interactions between the terminal device 102, the server 104, and the database server 106. It may be understood that when the terminal device 102 has the functions of the server 104 and the database server 106 that are required for performing the sheet data processing method, the sheet data processing method may also be performed by the terminal device 102 alone. It should be understood that the numbers of the terminal device 102, the server 104, the database server 106, and the user 108 in FIG. 1 are merely illustrative. There may be any number of terminal devices, users, servers, and database servers as desired.

In an exemplary application scenario, the user 108 may input or enter input data through the terminal device 102, and the server 104 may perform the sheet data processing method based on the input data, and provide a corresponding sheet data processing service for the user 108. An operation interface or a result (such as an updated data list) of the sheet data processing service is displayed on a page through the terminal device 102.

As described in the background section, in some examples, a node backend service may be configured to provide a formula calculation service. In some specific scenarios, the node backend service may be a Node.js backend service. However, as the data complexity increases and the amount of calculation increases, because the node backend service is a single-threaded calculation service, it is not suitable for CPU-intensive calculation scenarios. When facing scenarios involving a large amount of calculation, performance issues such as a long calculation time and high memory usage may occur. Therefore, a certain degree of adjustment is required.

In view of the above actual situation, an embodiment of the present disclosure provides a sheet data processing method. In the method, when calculation needs to be performed by using a node backend service, a calculation engine is introduced, data that needs to be calculated and a calculation formula are transmitted to the calculation engine, and the calculation engine is configured to perform formula calculation. On this basis, a data list affected by the calculation formula is determined, and only the data list is calculated, to implement calculation only based on an increment. In addition, after the calculation of the data list is completed, data items before and after the calculation of the data list are compared, to determine a data item that changes, and finally data updating is performed only on the data item that changes, to quickly complete updating of the data list. In this way, the calculation performance of the formula may be greatly improved by using the calculation capability of the calculation engine. In addition, the recalculation range after new input data is obtained and the range of final data updating are reduced by using the incremental calculation manner and result difference comparison updating, further improving the calculation efficiency and reducing the occupancy. Finally, the overall reaction efficiency is improved, the cost is reduced, and the user experience is greatly improved.

FIG. 2 is a schematic flowchart of an exemplary method 200 according to an embodiment of the present disclosure. Optionally, the method 200 may be configured to process sheet data, and in particular, may quickly respond in a node backend service scenario, improving the overall efficiency. The method 200 may be performed by the terminal device 102 in FIG. 1, or may be performed by the system 100 in FIG. 1.

As shown in FIG. 2, the sheet data processing method exemplarily provided in the embodiment of the present disclosure may specifically comprise the following steps.

Step 202: obtain input data in a sheet, and determine at least one calculation formula affected by the input data.

In this step, the sheet may be a sheet file used for data recording, which may contain more than one type of data, and the input data may be data input for a certain item or a certain column in the sheet. After that, the input data may be input by a user through a corresponding window, may be entered in batch by using a sheet, etc., or may be automatically obtained by the system according to settings. For example, in a sales scenario, the sheet may be used for turnover statistics and related data calculation and recording, and the input data may be a newly added sales volume data. Certainly, the sales volume may be newly generated in real time, or may be unrecorded sales volume data found during the reconciliation process. After the input data is obtained, it may be directly stored in a database, and at the same time, due to an attribute or a tag attached to the input data, a corresponding impact relationship may be determined for the input data, for example, data that may be affected by the input data or a calculation formula that may be affected by the input data. In a more specific example, after turnover data is input, according to prior settings, it may affect data such as daily turnover, monthly turnover, and a return on investment, and at the same time, different data may correspond to different calculation formulas that are set. Therefore, after the input data is entered, the affected calculation formula may be determined according to the input data.

Step 204: determine basic data corresponding to the calculation formula according to a node backend service, and write the input data and the basic data into a calculation engine.

In this step, as an example, the node backend service may be a Node.js backend service. The Node.js backend service is a service built on the Node. js platform, which may process HTTP requests and responses, interact with the database, and provide API interfaces for the frontend to call. The node backend service may be configured to determine, in the database, the basic data to be used in the calculation formula. For example, for the calculation formulas corresponding to the daily turnover and the monthly turnover in the foregoing example, the basic data may be all turnover data in a certain day or a certain month. After that, the input data and the basic data may be written into a structure in which formula calculation or recalculation needs to be performed later. In this solution, a calculation engine is added on the basis of the node backend service, and the formula calculation work is specifically performed by the calculation engine. In an example, a Rust calculation engine may be configured to perform subsequent corresponding formula calculation, and then data may be written into the Rust calculation engine. The input data here may also be considered as a part of the basic data for the database, and thus may be written in together.

It should be noted that the Rust calculation engine is a data processing engine written in Rust. As a system programming language, Rust focuses on safety, concurrency, and performance. It is close to C and C++ in terms of performance because it allows direct access to hardware resources and has no runtime or garbage collection overhead. At the same time, Rust provides strong support for concurrent programming, allowing developers to write efficient code running on multi-core processors. It helps avoid data races and other concurrency issues through immutable sharing, mutable borrowing, and sending/syncing traits. Therefore, concurrent asynchronous processing of data may be implemented by using the Rust calculation engine, and the data processing capability may be improved.

As the complexity of the calculation formula increases and the amount of basic data involved increases, if operations such as copying or writing of the data itself are directly performed, it will undoubtedly cause a certain system occupancy, which will increase the processing time and the memory usage. Therefore, in some examples, after the node backend service knows the storage location of the native binary data of the input data and the basic data, without further processing (such as reading, interpretation, etc.), the calculation engine may be directly informed of the storage location, so that the data is transmitted in the form of the native binary data. Specifically, after the node backend service knows the storage location of the native binary data of the input data and the basic data, the message will inform, in the form of a pointer, the node backend service of the location of the input data and the basic data. In a general process, the node backend service will find the data location according to the pointer, and then read the data. However, in this example, no further operations are performed on these pointers, and the pointers are directly informed to the calculation engine. When performing the calculation of one calculation formula, the calculation engine may directly find the corresponding native binary data according to the pointer, thereby establishing different data copies for different calculation formulas, and these data copies all point to the original data in the database. As a result, the calculation formulas may be asynchronously processed without affecting each other, and the response speed of data processing may be improved because only pointer transmission is performed. That is, in some examples, the writing the input data and the basic data into the calculation engine comprises: determining a storage location of native binary data of the input data and the basic data, and transmitting the storage location to the calculation engine in a form of pointer, so that the calculation engine finds, according to a corresponding pointer, native binary data corresponding to required data.

Further, in order to facilitate data access, in some examples, the input data and the basic data may be synchronously written into a basic storage block for formula calculation result storage. In some examples, the basic storage block here may be Base Storage. In a general formula calculation process, the basic storage block is generally configured to store some data that is unchanged in the formula calculation, such as a variable input by the user, a weight parameter in the formula, and some constants. After that, the calculation process will be performed in a data block. In some examples, the data block may be Data Chunk, and the calculation result will be temporarily stored in the data block. When the basic storage block changes, the data block will be cleared. Therefore, each time the data or metadata changes, the data block will be cleared, which will lead to full recalculation of the formula.

Step 206: determine a data list affected by the calculation formula by using the node backend service, and pass the calculation formula to the calculation engine to calculate the data list, to generate a calculation result.

In this step, when one piece of specific data is stored, other information may also be stored together. For example, when daily turnover data is stored, other information such as date and time information and personnel information may also be recorded. Therefore, the data is generally stored in the form of a sheet. Therefore, in this solution, the node backend service may first determine, in a corresponding storage file according to the calculation formula, the specific affected data list. Specifically, which column of data in the sheet needs to be recalculated may be determined, instead of recalculating and determining the entire sheet. That is, it may be understood as performing only incremental calculation.

It should be noted that in a specific scenario, the applicant has statistically analyzed the time-consuming of a write library link for 600,000 cells, and then statistically analyzed, on this basis, the proportion of data change before and after the write library. It may be seen from the statistical results that the time-consuming of the write library link for 600,000 cells is about 115 s, limited by the current data write library capability, such as the write library performance of the underlying relational database. In addition, after recalculating most actual formula scenarios, the proportion of unchanged formula calculation results is basically above 90%. Therefore, the unchanged formula calculation results may be trimmed before the write library, to reduce the time-consuming of the write library link. In order to trim the part in which the formula calculation result does not change, in this solution, the unaffected part and the unchanged part are eliminated by the incremental calculation in this step and the result difference comparison before and after the calculation in step 208.

In this example, after the affected data list is determined, the calculation formula may be transmitted to the calculation engine, so that the calculation engine recalculates the data in the data list, and the calculation result is generated. In this process, in order to more conveniently compare the data in the data list in a subsequent step, the data in the data list may be stored before the data calculation, and after the storage is completed, the data recalculation is performed. For example, a data list is configured to record the specific value of the daily turnover. For the convenience of data management, the data list generally records the daily turnover for one month, one year, or even more days, instead of only recording the daily turnover for one day. If new input data is entered, it may only affect the data of a certain data item in the data list, and thus the determination work in step 208 is required. Therefore, the data in the current data list may be recorded before the data recalculation of the data list. In a more specific example, the list data before the calculation may be stored in the base storage block to form comparison data. At the same time, in order to store the comparison data, the base storage block may add, to its structure, a data structure for describing a line calculation state of the formula, which is configured to store the comparison data.

That is, in some examples, the passing the calculation formula to the calculation engine to calculate the data list comprises: storing list data of the data list before the calculation into the base storage block to form comparison data; and retrieving the input data and the basic data from the base storage block, and recalculating the data list by using the calculation formula to generate calculation data. At the same time, for the base storage block, a data structure for describing a line calculation state of the formula may be added to the base storage block, and is configured to store the comparison data. In combination with the foregoing description, because the formula calculation process is generally performed in the data block, and the data block is cleared each time a change occurs, the data cannot be directly stored in the data block. Therefore, a new data structure may be constructed in the base storage block. The new data structure is configured to store the comparison data. After the data recalculation is completed in the data block, the calculation data is generated, and after the calculation data is transmitted to the base storage block, the comparison between the comparison data and the calculation data may be performed.

In some examples, a calculation formula in an application may comprise multi-level sub-formulas. For example, a calculation formula F1=F2+F3+C. To calculate the calculation formula F1, the calculation formula F2 and the calculation formula F3 need to be calculated first, and the calculation formula F2 and the calculation formula F3 may be considered as first-level sub-formula of the calculation formula F1. Therefore, when the calculation formula is passed to the calculation engine for calculation, the structure of the calculation formula may be first analyzed to determine at least one level of sub-formula comprised in the calculation formula, and then a topological sequence graph is formed according to the hierarchical relationship among these sub-formulas. Finally, the calculation formula is transmitted to the calculation engine in the form of the topological sequence graph, so that the calculation engine may determine the sequence of calculation between multi-level formulas according to the topological sequence graph, and perform calculation level by level. For formulas at the same level, synchronous multi-threaded calculation may be performed, to improve the calculation efficiency. That is, in some examples, the passing the calculation formula to the calculation engine to calculate the data list comprises: analyzing the calculation formula to determine at least one level of sub-formula comprised in the calculation formula; establishing a topological sequence graph of the calculation formula according to the at least one level of sub-formula; and passing the calculation formula to the calculation engine in a form of the topological sequence graph, so that the calculation engine performs calculation in sequence according to the topological sequence graph.

Further, in combination with the calculation formula F1=F2+F3+C in the foregoing example, in the node backend service, the calculation formula may only be divided at the formula level, and for the basic data field C in more detail, it may only be calculated when the F1 formula calculation is performed. The basic data field C here may be understood as some constant terms or hyperparameters calculated only by using simple basic data. The calculation amount of the basic data field C itself is different in different scenarios, which in turn affects the calculation efficiency to some extent. Therefore, in the calculation engine, because the calculation engine may theoretically perceive more expressions and details at the execution level, the basic data field C in the calculation formula F1 may be further determined on the basis of the foregoing example. Therefore, before the calculation, the basic data field C may be regarded as at least one level of sub-formula, and the topological sequence graph may be updated accordingly. Calculation is performed according to the updated topological sequence graph, so that the calculation efficiency may be further improved. For example, for the calculation formula F1=F2+F3+C, when calculating the sub-formulas at the level of F2 and F3, the basic data field C may be calculated at the same time. That is, in some examples, after the passing the calculation formula to the calculation engine in a form of the topological sequence graph, the method further comprises: analyzing, by the calculation engine, the calculation formula corresponding to the topological sequence graph to determine whether the calculation formula comprises a basic data field; and in response to the calculation formula comprising the basic data field, regarding the basic data field as the at least one level of sub-formula, and updating the topological sequence graph.

In some examples, in order to enable the calculation engine to more conveniently understand the calculation formula transmitted by the node backend service, the calculation formula may be compiled into a corresponding abstract syntax tree (AST), and the calculation formula may be transmitted to the calculation engine in the form of the abstract syntax tree. Specifically, for a calculation formula, the formula may be compiled at the node backend service stage, and a corresponding editor may be invoked to compile and return an abstract syntax tree. After that, a JSON structure is generated, by using serialization logic of the abstract syntax tree, to describe each node of the abstract syntax tree. Finally, the JSON structure is passed to the calculation engine for parsing, and the corresponding calculation formula is expanded in the calculation engine. That is, in some examples, the passing the calculation formula to the calculation engine to calculate the data list comprises: compiling the calculation formula into a corresponding abstract syntax tree according to a format requirement of the calculation engine; and transmitting the abstract syntax tree to the calculation engine.

Step 208: determine, according to the calculation result, a data item in the data list that changes after the calculation, and perform data updating on the data item.

In this step, according to the introduction and calculation in step 206, a new calculation result of the data list is calculated in the calculation engine, which is specifically the calculation data. After that, by determining the data item in the data list that changes after the calculation, the changed item may be determined in the data list, so that the data updating may be performed only for the changed item and related data.

With reference to the foregoing example, taking the data list of the daily turnover as an example, the daily turnover data for many days may be listed in the data list, and new input data may only correspond to the daily turnover data of a certain day, which may only affect one data item in the data list. Therefore, by comparing the data list before and after, the changed item may be determined, thereby realizing updating only the changed data item, and no processing is performed on others, so that the data processing speed may be further improved.

Certainly, in a specific application scenario, for different fields or different data, when comparison is performed, the specific structure for comparison may be different. For example, for hyperlink comparison, the IUrlSegment field in a specific cell of the sheet may be compared; and for geographic field comparison, the {locations: {poiInfo: IPoiInfo;}[];} field in a specific cell of the sheet may be compared.

Finally, with reference to the foregoing example, the process of determining the data item in the data list that changes after the calculation may be: comparing the comparison data with the calculation data to determine an item that changes, as the data item, to update the data item.

Step 210: display an updated data list in the sheet.

In this step, after the data list is updated, it may be output by display, and specifically, the updated data list may be displayed in the sheet. Certainly, the updated data list or sheet may be shown to the current operator or stored. That is, the updated data list or sheet may be displayed and output on a corresponding apparatus, to give corresponding feedback to the operator. Certainly, in some other examples, the output manner for the updated data list or sheet may not be limited to output display, and the updated data list or sheet may also be stored, displayed, used, or reprocessed. According to different application scenarios and implementation requirements, the specific output manner for the updated data list or sheet may be flexibly selected.

For example, for an application scenario in which the method in this example is performed on a single device, the updated data list or sheet may be directly output in a display manner on a display component (a display, a projector, etc.) of the current device, so that an operator of the current device may directly see the content of the updated data list or sheet on the display component.

For another example, for an application scenario in which the method in this example is performed on a system composed of a plurality of devices, the updated data list or sheet may be sent, through any data communication manner (a wired connection, NFC, Bluetooth, WiFi, a cellular mobile network, etc.), to another preset device as a receiver in the system, that is, a synchronization terminal, so that the synchronization terminal may perform subsequent processing on the updated data list or sheet. Optionally, the synchronization terminal may be a preset server. The server is generally set up in the cloud, as a data processing and storage center, which may store and distribute the updated data list or sheet. The receivers of the distribution are terminal devices, and the holders or operators of these terminal devices may be system operators (users), system maintenance personnel, data analysts, etc.

For still another example, when the method in this example is performed in the application scenario in which the method is performed on the system composed of the plurality of devices, the updated data list or sheet may be directly sent to a preset terminal device through any data communication manner, and the terminal device may be one or more of those listed in the foregoing paragraph.

It may be seen from the above embodiments that according to the sheet data processing method provided in the embodiments of the present disclosure, when calculation needs to be performed by using a node backend service, a calculation engine is introduced, data that needs to be calculated and a calculation formula are transmitted to the calculation engine, and the calculation engine is configured to perform formula calculation. On this basis, a data list affected by the calculation formula is determined, and only the data list is calculated, to implement calculation only based on an increment. In addition, after the calculation of the data list is completed, data items before and after the calculation of the data list are compared, to determine a data item that changes, and finally data updating is performed only on the data item that changes, to quickly complete updating of the data list. In this way, the calculation performance of the formula may be greatly improved by using the calculation capability of the calculation engine. In addition, the recalculation range after new input data is obtained and the range of final data updating are reduced by using the incremental calculation manner and result difference comparison updating, further improving the calculation efficiency and reducing the occupancy. Finally, the overall reaction efficiency is improved, the cost is reduced, and the user experience is greatly improved.

It should be noted that the method in the embodiments of the present disclosure may be performed by a single device, such as a computer or a server. The method in the embodiments of the present disclosure may also be applied to a distributed scenario, and be completed by a plurality of devices in cooperation with each other. In the case of such a distributed scenario, one of the plurality of devices may perform only a certain step or some steps in the method in the embodiments of the present disclosure, and the plurality of devices may interact with each other to complete the method.

It should be noted that the specific embodiments of the present disclosure have been described above. Other embodiments are within the scope of the appended claims. In some cases, the actions or steps recited in the claims may be performed in an order different from that in the foregoing embodiments and still achieve the desired results. In addition, the processes depicted in the drawings do not necessarily require the specific order or sequential order shown to achieve the desired results. In some implementations, multitasking and parallel processing are also possible or may be advantageous.

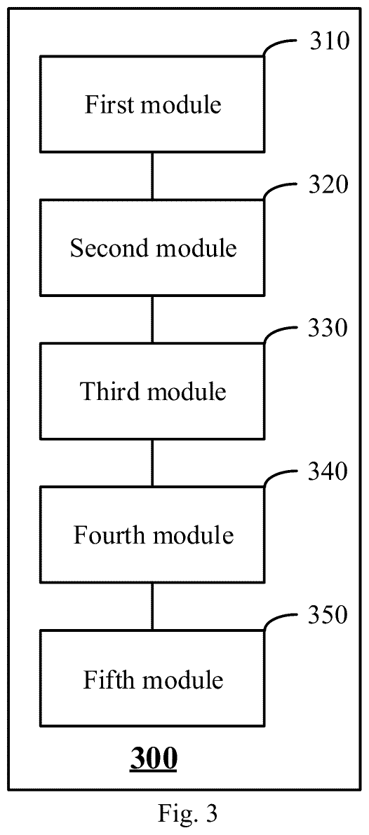

Based on the same technical concept, corresponding to the method in any one of the above embodiments, the present disclosure further provides a sheet data processing apparatus. FIG. 3 is a schematic diagram of an exemplary apparatus 300 according to an embodiment of the present disclosure. As shown in FIG. 3, the apparatus 300 may be configured to implement the method 200, and may further comprise the following modules.

The first module 310 is configured to obtain input data in a sheet, and determine at least one calculation formula affected by the input data.

The second module 320 is configured to determine basic data corresponding to the calculation formula according to a node backend service, and write the input data and the basic data into a calculation engine.

The third module 330 is configured to determine a data list affected by the calculation formula by using the node backend service, and pass the calculation formula to the calculation engine to calculate the data list, to generate a calculation result.

The fourth module 340 is configured to determine, according to the calculation result, a data item in the data list that changes after the calculation, and perform data updating on the data item.

The fifth module 350 is configured to display an updated data list in the sheet.

In some exemplary embodiments, the second module 320 is further configured to:
synchronously write the input data and the basic data into a base storage block for formula calculation result storage.

In some exemplary embodiments, the third module 330 is further configured to:
store list data of the data list before the calculation into the base storage block to form comparison data; and
retrieve the input data and the basic data from the base storage block, and recalculate the data list by using the calculation formula to generate calculation data.

In some exemplary embodiments, the fourth module 340 is further configured to:
compare the comparison data with the calculation data to determine an item that changes, as the data item, to update the data item.

In some exemplary embodiments, the base storage block comprises a data structure for describing a line calculation state of a formula, and is configured to store the comparison data.

In some exemplary embodiments, the third module 330 is further configured to:
analyze the calculation formula to determine at least one level of sub-formula comprised in the calculation formula;
establish a topological sequence graph of the calculation formula according to the at least one level of sub-formula; and
pass the calculation formula to the calculation engine in a form of the topological sequence graph, so that the calculation engine performs calculation in sequence according to the topological sequence graph.

In some exemplary embodiments, the third module 330 is further configured to:
analyze, by the calculation engine, the calculation formula corresponding to the topological sequence graph to determine whether the calculation formula comprises a basic data field; and
in response to the calculation formula comprising the basic data field, regard the basic data field as the at least one level of sub-formula, and update the topological sequence graph.

In some exemplary embodiments, the second module 320 is further configured to:
determine a storage location of native binary data of the input data and a storage location of native binary data of the basic data, and transmit the storage location of the native binary data of the input data and the storage location of the native binary data of the basic data to the calculation engine in a form of a pointer, so that the calculation engine finds, according to a corresponding pointer, the native binary data corresponding to required data.

In some exemplary embodiments, the third module 330 is further configured to:
compile the calculation formula into a corresponding abstract syntax tree according to a format requirement of the calculation engine; and
transmit the abstract syntax tree to the calculation engine.

For ease of description, when described, the above apparatus is divided into various modules based on functions. Certainly, when the present disclosure is implemented, the functions of the modules may be implemented in the same piece of software and/or hardware or in a plurality of pieces of software and/or hardware.

The apparatus in the above embodiments is configured to implement the corresponding method 200 in any one of the above embodiments, and has the beneficial effects of the corresponding embodiment of the method 200, which are not described herein again.

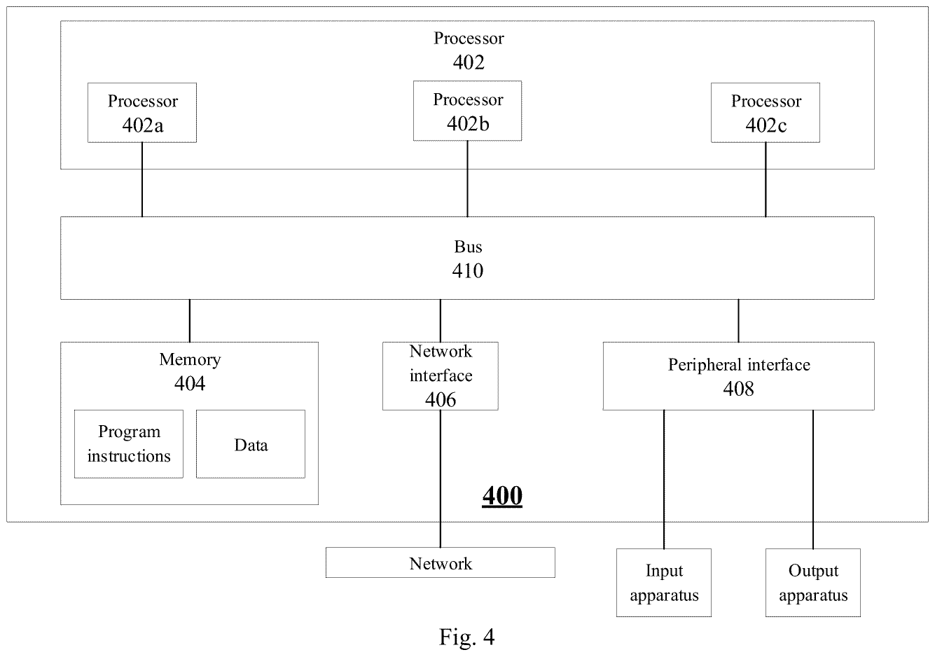

Based on the same technical concept, corresponding to the method in any one of the above embodiments, an embodiment of the present disclosure further provides a computer device for implementing the above method 200. FIG. 4 is a schematic diagram of a hardware structure of an exemplary computer device 400 according to an embodiment of the present disclosure. The computer device 400 may be configured to implement the terminal device 102 in FIG. 1. In some scenarios, the computer device 400 may also be configured to implement the server 104 and the database server 106 in FIG. 1.

As shown in FIG. 4, the computer device 400 may comprise: a processor 402, a memory 404, a network module 406, a peripheral interface 408, and a bus 410. The processor 402, the memory 404, the network module 406, and the peripheral interface 408 are communicatively connected to each other within the computer device 400 through the bus 410.

The processor 402 may be a central processing unit (Central Processing Unit, CPU), an image processor, a neural network processor (NPU), a microcontroller (MCU), a programmable logic device, a digital signal processor (DSP), an application specific integrated circuit (Application Specific Integrated Circuit, ASIC), or one or more integrated circuits. The processor 402 may be configured to perform a function related to the technologies described in the present disclosure. In some embodiments, the processor 402 may further comprise a plurality of processors integrated into a single logic component. For example, as shown in FIG. 4, the processor 402 may comprise a plurality of processors 402a, 402b, and 402c.

The memory 404 may be configured to store data (for example, instructions, computer code, etc.). As shown in FIG. 4, the data stored in the memory 404 may comprise program instructions (for example, program instructions for implementing the method 200 in the embodiments of the present disclosure) and data to be processed (for example, the memory may store configuration files of other modules, etc.). The processor 402 may also access the program instructions and the data stored in the memory 404, and execute the program instructions to operate on the data to be processed. The memory 404 may comprise a volatile storage apparatus or a non-volatile storage apparatus. In some embodiments, the memory 404 may comprise a random access memory (RAM), a read-only memory (ROM), an optical disc, a magnetic disk, a hard disk, a solid state disk (SSD), a flash memory, a memory stick, etc.

The network interface 406 may be configured to provide, via a network, communication between the computer device 400 and other external devices. The network may be any wired or wireless network capable of transmitting and receiving data. For example, the network may be a wired network, a local wireless network (for example, Bluetooth, WiFi, near field communication (NFC), etc.), a cellular network, the Internet, or a combination thereof. It may be understood that the type of the network is not limited to the above specific examples.

The peripheral interface 408 may be configured to connect the computer device 400 to one or more peripheral apparatuses to enable information input and output. For example, the peripheral apparatuses may comprise input apparatus such as a keyboard, a mouse, a touchpad, a touch screen, a microphone, and various sensors, and output apparatus such as a display, a speaker, a vibrator, and an indicator light.

The bus 410 may be configured to transfer information between various components (for example, the processor 402, the memory 404, the network interface 406, and the peripheral interface 408) of the computer device 400, such as an internal bus (for example, a processor-memory bus), an external bus (a USB port, a PCI-E bus), etc.

It should be noted that although only the processor 402, the memory 404, the network interface 406, the peripheral interface 408, and the bus 410 are shown in the architecture of the computer device 400, during a specific implementation, the architecture of the computer device 400 may further comprise other components necessary for proper operation. Furthermore, it may be understood by those skilled in the art that the architecture of the computer device 400 may comprise only the components necessary for implementing the solutions in the embodiments of the present disclosure, and not necessarily comprise all the components shown in the figure.

Based on the same technical concept, corresponding to the method in any one of the above embodiments, the present disclosure further provides a non-transitory computer-readable storage medium for storing computer instructions thereon, where the computer instructions, when executed by at least a computer, cause the computer to perform the method 200 in any one of the above embodiments.

The computer-readable medium in this embodiment comprises permanent and non-permanent, removable and non-removable media, and information storage may be implemented by using any method or technology. Information may be computer-readable instructions, a data structure, a module of a program, or other data. Examples of the computer storage medium comprise, but are not limited to, a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette tape, tape or disk storage or another magnetic storage device, or any other non-transmission medium that may be used to store information capable of being accessed by a computing device.

The computer instructions stored on the storage medium in the above embodiments are configured to cause the computer to perform the method 200 in any one of the above embodiments, and have the beneficial effects of the corresponding method embodiment, which are not described herein again.

Based on the same technical concept, corresponding to the method 200 described in any one of the above embodiments, the present disclosure further provides a computer program product, comprising computer program instructions that, when executed on a computer, cause the computer to perform the method 200 described in any one of the above embodiments. In some embodiments, the computer program instructions may be executed by one or more processors of the computer to cause the computer and/or the processors to perform the method 200. Corresponding to the execution body corresponding to each step in each embodiment of the method 200, the processor that executes the corresponding step may belong to the corresponding execution body.

The computer program product in the above embodiments is configured to cause the computer and/or the processor to perform the method 200 described in any one of the above embodiments, and has the beneficial effects of the corresponding method embodiment, which are not described herein again.

It should be understood by those of ordinary skill in the art to which this disclosure pertains that the discussion of any one of the above embodiments is merely exemplary, and is not intended to imply that the scope of the present disclosure (comprising the claims) is limited to these examples; and with the concept of the present disclosure, the technical features in the above embodiments or different embodiments may also be combined, the steps may be implemented in any order, many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the foregoing description. For example, the discussed embodiments may be used for other memory architectures such as a dynamic RAM (DRAM).

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be comprised within the scope of protection of the present disclosure.

1. A method for processing sheet data, comprising:
obtaining input data in a sheet, and determining at least one calculation formula affected by the input data;
determining basic data corresponding to the calculation formula according to a node backend service, and writing the input data and the basic data into a calculation engine;
determining a data list affected by the calculation formula by using the node backend service, and passing the calculation formula to the calculation engine to calculate the data list, to generate a calculation result;
determining, according to the calculation result, a data item in the data list that changes after the calculation, and performing data updating on the data item; and
displaying an updated data list in the sheet.

2. The method of claim 1, wherein the writing the input data and the basic data into a calculation engine comprises:
synchronously writing the input data and the basic data into a base storage block for formula calculation result storage.

3. The method of claim 2, wherein the passing the calculation formula to the calculation engine to calculate the data list comprises:
storing list data of the data list before the calculation into the base storage block to form comparison data; and
retrieving the input data and the basic data from the base storage block, and recalculating the data list by using the calculation formula to generate calculation data.

4. The method of claim 3, wherein the determining a data item in the data list that changes after the calculation comprises:
comparing the comparison data with the calculation data to determine an item that changes, as the data item, to update the data item.

5. The method of claim 3, wherein the base storage block comprises a data structure for describing a line calculation state of a formula, and is configured to store the comparison data.

6. The method of claim 1, wherein the passing the calculation formula to the calculation engine to calculate the data list comprises:
analyzing the calculation formula to determine at least one level of sub-formula comprised in the calculation formula;
establishing a topological sequence graph of the calculation formula according to the at least one level of sub-formula; and
passing the calculation formula to the calculation engine in a form of the topological sequence graph, so that the calculation engine performs calculation in sequence according to the topological sequence graph.

7. The method of claim 6, wherein after the passing the calculation formula to the calculation engine in a form of the topological sequence graph, the method further comprises:
analyzing, by the calculation engine, the calculation formula corresponding to the topological sequence graph to determine whether the calculation formula comprises a basic data field; and
in response to the calculation formula comprising the basic data field, regarding the basic data field as the at least one level of sub-formula, and updating the topological sequence graph.

8. The method of claim 1, wherein the writing the input data and the basic data into a Rust calculation engine comprises:
determining a storage location of native binary data of the input data and a storage location of native binary data of the basic data, and transmitting the storage location of the native binary data of the input data and the storage location of the native binary data of the basic data to the calculation engine in a form of a pointer, so that the calculation engine finds, according to a corresponding pointer, the native binary data corresponding to required data.

9. The method of claim 1, wherein the passing the calculation formula to the calculation engine to calculate the data list comprises:
compiling the calculation formula into a corresponding abstract syntax tree according to a format requirement of the calculation engine; and
transmitting the abstract syntax tree to the calculation engine.

10. A computer device, comprising at least a memory, at least a processor, and a computer program stored in the memory and executable by the processor, wherein the processor, when executing the program, implements a method for processing sheet data, which comprises:
obtaining input data in a sheet, and determining at least one calculation formula affected by the input data;
determining basic data corresponding to the calculation formula according to a node backend service, and writing the input data and the basic data into a calculation engine;
determining a data list affected by the calculation formula by using the node backend service, and passing the calculation formula to the calculation engine to calculate the data list, to generate a calculation result;
determining, according to the calculation result, a data item in the data list that changes after the calculation, and performing data updating on the data item; and
displaying an updated data list in the sheet.

11. The computer device of claim 10, wherein the writing the input data and the basic data into a calculation engine comprises:
synchronously writing the input data and the basic data into a base storage block for formula calculation result storage.

12. The computer device of claim 11, wherein the passing the calculation formula to the calculation engine to calculate the data list comprises:
storing list data of the data list before the calculation into the base storage block to form comparison data; and
retrieving the input data and the basic data from the base storage block, and recalculating the data list by using the calculation formula to generate calculation data.

13. The computer device of claim 12, wherein the determining a data item in the data list that changes after the calculation comprises:
comparing the comparison data with the calculation data to determine an item that changes, as the data item, to update the data item.

14. The computer device of claim 12, wherein the base storage block comprises a data structure for describing a line calculation state of a formula, and is configured to store the comparison data.

15. The computer device of claim 10, wherein the passing the calculation formula to the calculation engine to calculate the data list comprises:
analyzing the calculation formula to determine at least one level of sub-formula comprised in the calculation formula;
establishing a topological sequence graph of the calculation formula according to the at least one level of sub-formula; and
passing the calculation formula to the calculation engine in a form of the topological sequence graph, so that the calculation engine performs calculation in sequence according to the topological sequence graph.

16. The computer device of claim 15, wherein after the passing the calculation formula to the calculation engine in a form of the topological sequence graph, the method further comprises:
analyzing, by the calculation engine, the calculation formula corresponding to the topological sequence graph to determine whether the calculation formula comprises a basic data field; and
in response to the calculation formula comprising the basic data field, regarding the basic data field as the at least one level of sub-formula, and updating the topological sequence graph.

17. The computer device of claim 10, wherein the writing the input data and the basic data into a Rust calculation engine comprises:
determining a storage location of native binary data of the input data and a storage location of native binary data of the basic data, and transmitting the storage location of the native binary data of the input data and the storage location of the native binary data of the basic data to the calculation engine in a form of a pointer, so that the calculation engine finds, according to a corresponding pointer, the native binary data corresponding to required data.

18. The computer device of claim 10, wherein the passing the calculation formula to the calculation engine to calculate the data list comprises:
compiling the calculation formula into a corresponding abstract syntax tree according to a format requirement of the calculation engine; and
transmitting the abstract syntax tree to the calculation engine.

19. A non-transitory computer-readable storage medium for storing computer instructions thereon, wherein the computer instructions, when executed by at least a computer, cause the computer to perform a method for processing sheet data, which comprises:
obtaining input data in a sheet, and determining at least one calculation formula affected by the input data;
determining basic data corresponding to the calculation formula according to a node backend service, and writing the input data and the basic data into a calculation engine;
determining a data list affected by the calculation formula by using the node backend service, and passing the calculation formula to the calculation engine to calculate the data list, to generate a calculation result;
determining, according to the calculation result, a data item in the data list that changes after the calculation, and performing data updating on the data item; and
displaying an updated data list in the sheet.

20. The storage medium of claim 19, wherein the writing the input data and the basic data into a calculation engine comprises:
synchronously writing the input data and the basic data into a base storage block for formula calculation result storage.
